(19) United States
(12) Patent Application Publication
(10) Pub. No.: US 2024/0346938 A1
(43) Pub. Date: Oct. 17, 2024

(54) AUTOMATIC GENERATION OF A FLIGHT PATH FOR TARGET ACQUISITION

(71) Applicant: ISRAEL AEROSPACE INDUSTRIES LTD., Lod (IL)

(72) Inventor: Ohad ROZENBERG, Yad Binyamin (IL)

(21) Appl. No.: 18/682,211

(22) PCT Filed: Jul. 25, 2022
(86) PCT No.: PCT/IL2022/050799

§ 371 Date: Feb. 8, 2024

(30) Foreign Application Priority Data
Aug. 9, 2021 (IL) 285486

(51) Int. Cl. G08G 5/00; G05D 1/229; G05D 1/644; G05D 1/689; G05D 109/20

(52) U.S. Cl. CPC G08G 5/0034; G08G 5/0026; G05D 1/229; G05D 1/6445; G05D 1/689; G05D 2109/20

(57) ABSTRACT

A method comprising, by a processor and memory circuitry, for an aerial vehicle comprising a payload operative to perform an interaction with a target: for each target of a plurality of targets, determining an interaction area based on a position of the target, wherein, for each position of the aerial vehicle located in the interaction area of the target, the interaction between the payload and the target is enabled according to an operability criterion, generating a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections, and obtaining a flight path for the aerial vehicle using the series of connections.

### CROSS-REFERENCE TO A RELATED APPLICATION

The present application claims benefit from IL285486 filed on Aug. 9, 2021.

### TECHNOLOGICAL FIELD

The invention is in the field of generating a flight path for an aerial vehicle.

### BACKGROUND

A flight path defines the path to be followed by an aerial vehicle. The flight path depends on various constraints of the mission to be performed by the aerial vehicle.

References considered to be relevant as background to the presently disclosed subject matter are listed below (acknowledgement of the references herein is not to be inferred as meaning that these are in any way relevant to the patentability of the presently disclosed subject matter):
US2020202115;
U.S. Pat. No. 8,718,838;
U.S. Ser. No. 10/618,673;
WO2018232447.

There is now a need to propose new systems and methods of generating a flight path for an aerial vehicle.

### General Description

In accordance with certain aspects of the presently disclosed subject matter, there is provided a method comprising, by a processor and memory circuitry (PMC), for an aerial vehicle comprising a payload operative to perform an interaction with a target: for each target of a plurality of targets, determining an interaction area based on a position of the target, wherein, for each position of the aerial vehicle located in the interaction area of the target, the interaction between the payload and the target is enabled according to an operability criterion, generating a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections, and obtaining a flight path for the aerial vehicle using the series of connections.

In addition to the above features, the method according to this aspect of the presently disclosed subject matter can optionally comprise one or more of features (i) to (xxi) below, in any technically possible combination or permutation:
i. the method comprises, during a flight of the aerial vehicle:
   (1) for a period of time Tᵢ of the flight of the aerial vehicle:
   for each target of a plurality of targets, obtaining an interaction area based on a position of the target at the period of time Tᵢ,
   wherein, for each position of the aerial vehicle located in the interaction area of the target, the interaction between the payload and the target is enabled according to an operability criterion,
   wherein at least one target of the plurality of targets is a moving target,
   generating a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections,
   obtaining a flight path FPᵢ for the aerial vehicle using the series of connections,
   (2) repeating (1) at least once for a period of time Tᵢ₊₁ different from Tᵢ, wherein the moving target has a position at time Tᵢ₊₁ different from time Tᵢ, to generate an updated flight path FPᵢ₊₁ for the aerial vehicle.
ii. the payload comprises an acquisition device and the interaction with the target comprises an acquisition of the target by the acquisition device;
iii. the interaction area of each target is determined based on a maximal zoom-in capability of the acquisition device;
iv. generating the series of connections comprises determining a connection between a waypoint of a given connection of the series of connections and an interaction area of a next target, said determining comprising selecting the connection among one of:
   a connection which comprises the waypoint and is orthogonal to a tangent to a boundary of the interaction area of the next target;
   a connection which comprises the waypoint and is tangent to the boundary of the interaction area of the next target;
   a connection which intersects an interior area of the interaction area of the next target;
v. for at least one given target of the plurality of targets associated with a given interaction area, a given connection of the series of connections comprises a waypoint located at a boundary of said given interaction area, said waypoint having a position different from a position of the given target;
vi. generating the series of connections comprises generating a connection from a starting waypoint, said generating comprising:
   determining a first target among the plurality of targets, for which a first candidate connection C₁ meets an optimization criterion, wherein the first candidate connection C₁ comprises a first waypoint W_{1,1} corresponding to the starting waypoint, and a second waypoint C_{1,2} located at a boundary of an interaction area of the first target, wherein the first candidate connection C₁ is orthogonal to said boundary;
vii. the optimization criterion takes into account at least one of:
   (i) a length of the first candidate connection C₁; and
   (ii) a level of priority of the first target;
viii. the method comprises determining a second target among the plurality of targets, for which a second candidate connection C₂ comprising the second waypoint W_{1,2} and a third waypoint W_{2,1} located at a boundary of an interaction area of the second target meets an optimization criterion, wherein the second candidate connection C₂ is orthogonal to said boundary;
ix. the method comprises, after identification of the first target and the second target:
   performing a comparison between:
      a first series of connections comprising the first candidate connection C₁ and the second candidate connection C₂, and
      a second series of connections comprising a first candidate connection C′₁ comprising the first waypoint C_{1,1} and a second waypoint W′_{1,2} located at a boundary of the interaction area of the first target, wherein the first candidate connection C′₁ is tangent to the boundary of the interaction area of the first target at said second waypoint W′_{1,2},
   generating the series of connections based on the comparison;
x. generating the series of connections comprises: determining an order among targets of the plurality of targets for generating the series of connections, wherein a second target is consecutive to a first target according to said order, and determining a candidate connection which intersects at least one of: an interior area of an interaction area of the first target, and an interior area of an interaction area of the second target, using said candidate connection for generating the series of connections;
xi. the method comprises obtaining at least one forbidden area, and generating the series of connections, wherein each connection of the series of connections does not comprise any waypoint located in the forbidden area;
xii. the method comprises dividing the plurality of targets into a plurality of clusters, wherein at least one cluster comprises at least two targets of the plurality of targets, wherein said dividing is based on a distribution of distance between the targets, determining an order between the plurality of clusters, and generating the flight path, wherein said flight path follows said order between the plurality of clusters;
xiii. the method comprises determining the order between the plurality of clusters uses at least one of: a distance between a center of mass of each cluster and an initial position from which the flight path is to be generated; a number of targets of each cluster; data informative of a level of priority of the one or more targets of each cluster;
xiv. the method comprises, for at least one given cluster of the plurality of clusters, determining an order between targets of the given cluster according to a decreasing distance with respect to a next cluster being after said given cluster, and generating the flight path, wherein said flight path follows said order between the targets of the given cluster;
xv. the method comprises identifying at least one given connection which has a length which differs from a length of other connections of the series of connections according to a criterion, generating an updated series of connections, which does not comprise said given connection, and has a length which is smaller than a length of the series of connections;
xvi. for each position of the aerial vehicle located in the interaction area of said target, the interaction between the payload and said target is enabled according to the operability criterion, and for each position of the aerial vehicle located outside the given interaction area, the interaction between the payload and the given target is not enabled according to the operability criterion;
xvii. the method comprises, for at least one target of the plurality of targets: obtaining data informative of a position of the target and data informative of a dimension of the target, using the data informative of a position of the target and the data informative of a dimension of the target to determine the interaction area of the target;
xviii. the series of connections is generated progressively, wherein generation of said series of connections comprises determining a connection between a current waypoint and an interaction area of a next target, wherein the next area is determined based on at least one of: a distance between the current waypoint and the interaction area of the next target; and a level of priority of the next target indicative of a priority to perform an interaction between the payload and the next target;
xix. the method comprises, for a given period of time T₁: determining a given moving target among the plurality of targets for which a distance between a position of the aerial vehicle at time T₁ and a position of the given moving target at time T₁ or an interaction area of the given moving target at time T₁ meets a criterion, estimating a time ΔT_{target} for the aerial vehicle to reach the given moving target or the interaction area of the given moving target, predicting position of one or more moving targets of the plurality of targets at time T₁+ΔT_{target}, generating a connection between the position of the aerial vehicle at time T₁ and an interaction area of a given target of the plurality of targets, wherein the interaction area is estimated for a position of the given target at time T₁+ΔT_{target};
xx. a distance between a position of the aerial vehicle at time T₁ and a position of the given target at time T₁+ΔT_{target} or an interaction area of the given target at time T₁+ΔT_{target} meets the criterion; and
xxi. the method comprises, for the given period of time T₁:
   (10) determining a given moving target among the plurality of targets for which a distance between a starting waypoint Wᵢ and a position of the given moving target
at time Tᵢ or an interaction area of the given moving target at time Tᵢ meets a criterion, wherein, at a first iteration of (10), Tᵢ is equal to T₁ and Wᵢ corresponds to a position of the aerial vehicle at time T₁,
(11) estimating a future time Tᵢ₊₁ at which the aerial vehicle, starting from Wᵢ, will reach the given moving target or the interaction area of the given moving target,
(12) predicting position of one or more moving targets of the plurality of targets at time Tᵢ,
(13) generating a connection between Wᵢ and an interaction area of a given target of the plurality of targets, wherein the interaction area is estimated for a position of the given target at time Tᵢ₊₁, wherein a distance between Wᵢ and a position of the given target at time Tᵢ₊₁ or an interaction area of the given target at time Tᵢ₊₁ meets the criterion,
(14) repeating (10) to (13) at least once, wherein for said repeating Wi is set equal to an extremity of the connection determined at (13) and Ti is set equal to Ti+1.

In accordance with other aspects of the presently disclosed subject matter, there is provided a system comprising a processor and memory circuitry (PMC) configured to perform, for an aerial vehicle comprising a payload operative to perform an interaction with a target, the method as described above.

In accordance with other aspects of the presently disclosed subject matter, there is provided a non-transitory storage device readable by a machine, tangibly embodying a program of instructions executable by the machine to perform, for an aerial vehicle comprising a payload operative to perform an interaction with a target, the method as described above.

In accordance with other aspects of the presently disclosed subject matter, there is provided an aerial vehicle comprising a payload operative to perform an interaction with a target and a processor and memory circuitry (PMC) configured to perform the method as described above.

According to some embodiments, the proposed solution is able to generate automatically an optimized flight path for an aerial vehicle.

According to some embodiments, the proposed solution generates an optimized flight path for an aerial vehicle without requiring intervention of an operator.

According to some embodiments, the proposed solution generates a flight path for an aerial vehicle which enables acquisition of a plurality of targets by an imaging device of the aerial vehicle.

According to some embodiments, the proposed solution improves operational performance of an aerial vehicle, such as a UAV.

According to some embodiments, the proposed solution optimizes the length of the flight path while taking into account the level of priority of the targets to be acquired.

According to some embodiments, the proposed solution generates the flight path in real time or quasi real time.

According to some embodiments, the proposed solution enables the aerial vehicle to perform an acquisition of targets while avoiding forbidden areas.

According to some embodiments, the proposed solution computes an optimized flight path without requiring intensive usage of processing resources.

According to some embodiments, the proposed solution generates an optimized flight path for acquiring targets, even if the targets are mobile.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates an architecture of a system according to some embodiments of the invention;

FIG. 2 illustrates, at a given period of time, a non-limitative example of a map of a plurality of targets with which the aerial vehicle has to interact;

FIG. 3 illustrates an embodiment of a method of generating a flight path which enables the aerial vehicle to interact with a plurality of targets;

FIG. 4 illustrates an embodiment of a method of determining an interaction area of a target;

FIG. 5A illustrates an embodiment of a method of dividing a plurality of targets into a set of ordered clusters;

FIG. 5B illustrates a non-limitative example of the method of FIG. 5A;

FIG. 6A illustrates an embodiment of a method of determining a first target and a connection to this first target;

FIG. 6B illustrates a non-limitative example of the method of FIG. 6A;

FIG. 6C illustrates an embodiment of a method of determining a second target and a connection to this second target;

FIG. 6D illustrates a non-limitative example of the method of FIG. 6C;

FIG. 6E illustrates an embodiment of a method of testing two candidate series of connections between a first target and a second target;

FIG. 6F illustrates a non-limitative example of the method of FIG. 6E;

FIG. 6G illustrates an embodiment of a method of testing connections which intersect an interior area of an interaction area of a first target and/or of a second target;

FIG. 6H illustrates a non-limitative example of the method of FIG. 6G;

FIG. 7A illustrates an embodiment of a method of generating connections which avoid a forbidden area;

FIG. 7B illustrates a non-limitative example of the method of FIG. 7A;

FIG. 8A illustrates a method of determining irregularity in the length of a connection of a series of connections;

FIG. 8B illustrates a non-limitative example of the method of FIG. 8A;

FIG. 9A illustrates an embodiment of a method of generating a flight path which enables the aerial vehicle to interact with a plurality of targets, wherein the method takes into account a motion of at least one moving target;

FIG. 9B illustrates, at a given period of time, a non-limitative example of a map of a plurality of targets with which the aerial vehicle has to interact; and

FIG. 9C illustrates, at a predicted period of time, a non-limitative example of a map of the plurality of targets of FIG. 9B.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

The term “processor and memory circuitry” (PMC) as disclosed herein should be broadly construed to include any kind of electronic device with data processing circuitry, which includes for example a computer processing device operatively connected to a computer memory (e.g. digital signal processor (DSP), a microcontroller, a field programmable gate array (FPGA), and an application specific integrated circuit (ASIC), etc.) capable of executing various data processing operations.

Unless specifically stated otherwise, as apparent from the following discussions, it is appreciated that throughout the specification discussions utilizing terms such as “using”, “generating”, “determining”, “obtaining”, “transmitting”, “dividing”, “comparing” or the like, refer to the action(s) and/or process(es) of a processor and memory circuitry that manipulates and/or transforms data into other data, said data represented as physical, such as electronic, quantities and/or said data representing the physical objects.

It can encompass a single processor or multiple processors, which may be located in the same geographical zone or may, at least partially, be located in different zones and may be able to communicate together.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

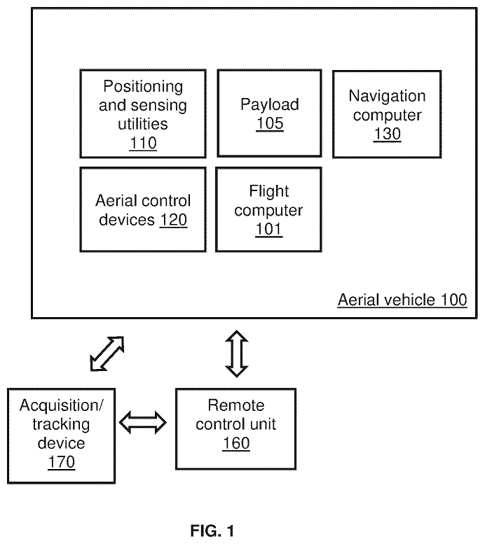

Attention is drawn to FIG. 1.

An aerial vehicle 100 includes a payload 105 operative to perform an interaction with at least one target.

The aerial vehicle 100 corresponds e.g. to an aircraft, a helicopter, a UAV (unmanned aerial vehicle), a balloon, etc.

The UAV can be fully autonomous or can be controlled by an operator located at a remote central station, or is both controlled remotely and operates autonomously.

According to some embodiments, payload 105 is operative to acquire a target. In some embodiments, payload 105 includes an imaging device (e.g. a camera), a radar, a LIDAR, etc.

According to some embodiments, payload 105 is operative to perform a physical interaction (e.g. destructive interaction) with the target (and not only a remote acquisition). For example, payload 105 includes a laser operative to remove material from the target, a device enabling launch of a projectile to annihilate the target, etc.

Although reference will be made hereinafter to the acquisition of a target by the payload, it is to be understood that this is not limitative, and other interactions can be performed with the target(s), as explained above.

The aerial vehicle 100 comprises aircraft positioning and sensing utilities 110 such as air speed detector (e.g. Pitot tube), GPS receiver, inertial navigation system (INS), altimeter (e.g. pressure altimeter, sonic altimeter, radar altimeter, GPS based altimeter, etc.), etc. These devices are used for determining aircraft situation data including: current position and attitude (six degrees of freedom), heading, and speed of the aerial vehicle.

The aerial vehicle 100 comprises aerial control devices 120 which include, for example, elevators, ailerons, flaps, rudder, throttle, wheels, and others. Elevators enable the plane to go up and down through the air. The elevators change the horizontal stabilizer's angle of attack, and the resulting lift either raises the rear of the aircraft (pointing the nose down) or lowers it (pointing the nose skyward). Ailerons are horizontal flaps located near the end of an airplane's wings. Ailerons allow one wing to generate more lift than the other, resulting in a rolling motion that allows the plane to bank left or right. A rudder is a flap located on the vertical tail wing. The rudder enables the plane to turn left or right. Throttle enables to increase/decrease thrust. Wheels may be used during landing.

The aerial vehicle 100 comprises a flight computer 120 (including a PMC), which is configured to control and manage the operations of various sub-systems and devices on-board the aerial vehicle 100 during a mission.

Flight computer 101 can control sub-systems related to takeoff and landing, navigation, payload activation, etc. In particular, flight computer 101 controls various aerial control devices 120 for the purpose of controlling the motion of the aerial vehicle 100 along a flight path.

A flight path (also called flight route) defines the path to be followed by the aerial vehicle 100 during its mission. The flight path can comprise a series of points (also called waypoints (WPs)) defining the path of the aerial vehicle. Each waypoint can comprise coordinates (e.g. latitude/longitude—in some embodiments, each waypoint can also comprise an altitude).

In some embodiments, the flight path is defined by a trajectory to be followed by the aerial vehicle, and, in particular, by a series of connections joining a series of waypoints.

According to some embodiments, the flight path is generated by a navigation computer 130 embedded on the aerial vehicle 100. The navigation computer 130 comprises a processor and memory circuitry.

According to some embodiments, the flight path is generated by another entity communicating with the aerial vehicle 100. For example, a remote control unit 160 (which comprises a PMC) generates the flight path and communicates the flight path to the aerial vehicle 100, using remote communication (e.g. radio communication, satellite communication, etc.).

In some embodiments, an operator uses the remote control unit 160 to transmit commands to the aerial vehicle 100. These commands can include e.g. navigation commands, control of an operation of the payload 105, etc.

According to some embodiments, the flight path is generated both by the navigation computer 130 and by the remote control unit 160.

According to some embodiments, at least one acquisition and/or tracking device 170 is operative to acquire data informative of a plurality of targets. Device 170 include e.g. a radar, a camera, COMINT (communications intelligence) sensor, ELINT (electronic intelligence) sensor, AIS, a device providing input to the aircraft or to the remote control unit, etc. As explained hereinafter, device 170 can e.g. determine (or at least estimate) position of the targets (in particular, position over time), velocity of the targets, a dimension of the targets (e.g. a size of the target), etc. In some embodiments, position and/or velocity and/or dimensions of one or more targets are provided automatically by a sensor and/or manually by an operator (e.g. to the aerial vehicle 100 and/or to the remote control unit 160).

According to some embodiments, device 170 can track one or more targets over time. In some embodiments, device 170 can predict the trajectory of targets over time.

According to some embodiments, device 170 can communicate data with the aerial vehicle 100 and/or with the remote control unit 160.

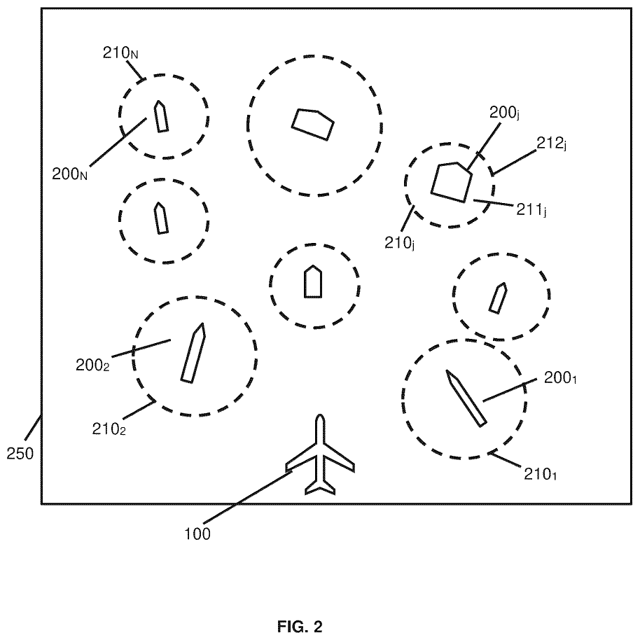

Attention is now drawn to FIG. 2.

FIG. 2 depicts, at a given period of time, a position (latitude, longitude) of a plurality of targets 200₁ to 200_{N}. Targets are spread over an area 250.

According to some embodiments, at least some of the targets 200₁ to 200_{N} are located at sea (in some embodiments, each target includes at least a part which is located above sea level). The targets at sea can include e.g. marine vessels, icebergs, buoys, etc. These examples are not limitative.

According to some embodiments, at least some of the targets 200₁ to 200_{N} are located on ground. This can include for example a ground vehicle, a person, a building, etc. These examples are not limitative.

According to some embodiments, at least some of the targets 200₁ to 200_{N} are located in the air. This can include for example an aircraft, a UAV, a balloon, a helicopter, etc. These examples are not limitative.

According to some embodiments, at least one of targets 200₁ to 200_{N} is a static target (meaning that the position is fixed and does not vary over time).

According to some embodiments, at least one of targets 200₁ to 200_{N} is a mobile target (meaning that its position varies over time).

According to some embodiments, the mission of the aerial vehicle 100 comprises acquiring, using its payload 105, all targets 200₁ to 200_{N} (or at least a subset of these targets 200₁ to 200_{N}).

In order to perform this mission, a flight path is to be generated for the aerial vehicle 100. As explained hereinafter, in some embodiments, the flight path is periodically updated, since at least some of the targets are mobile over time.

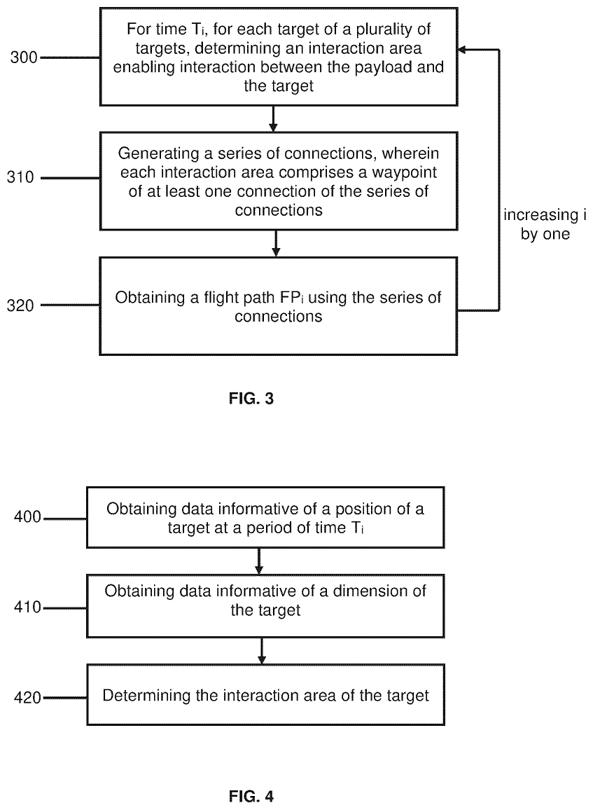

Attention is now drawn to FIG. 3, which depicts a method of generating a flight path for the aerial vehicle 100.

Assume that the mission requires acquisition of targets 200₁ to 200_{N}.

According to some embodiments, a flight path is generated for the aerial vehicle 100 during the flight of the aerial vehicle 100. Assume that at a period of time Tᵢ (as explained hereinafter, in some embodiments, the method is iterative—at the first iteration, i=1), the aerial vehicle 100 has a position P_{aerial, i}.

The method includes, for each target of the plurality of targets 200₁ to 200_{N} (or for at least some of them), determining (operation 300) an interaction area 210₁ to 210_{N}.

The interaction area is an area for which, for each position (latitude/longitude) of the aerial vehicle 100 located within the interaction area, the interaction between the payload 105 of the aerial vehicle 100 and the target is enabled according to an operability criterion.

Assume for example that the mission requires acquisition of a target 200ⱼ. As a consequence, if the aerial vehicle 100 has a position in the interaction area 210ⱼ (note that the interaction area 210ⱼ includes both an interior area 211ⱼ of the interaction area 210ⱼ and a boundary 212ⱼ of the interaction area 210ⱼ), its payload 105 can acquire the target 200ⱼ. To the contrary, if the aerial vehicle 100 has a position which is outside the interaction area 210ᵢ (note that a position on the boundary 212ⱼ is considered as being in the interaction area 210ⱼ), its payload 105 cannot acquire the target 200ⱼ.

The operability criterion can define e.g. a quality parameter/a threshold (such as a signal to noise ratio, a resolution, a relative size of the target with respect to the frame, etc.) for which it can be considered that the payload 105 is able to acquire the target. Below this threshold, it can be considered that the payload 105 is not able to acquire the target (e.g. because the resolution and/or the signal to noise ratio and/or the relative size of the target in the image is too low, etc.).

According to some embodiments, the operability criterion can be different for each target. For example, for sensitive targets, a harsher threshold is imposed (meaning that for a given size of a target, the interaction area will be of smaller size), whereas for low sensitive targets, a relaxed threshold is imposed (meaning that for a given size of a target, the interaction area will be of larger size).

According to some embodiments, the size of the interaction area does not depend on the altitude of the aerial vehicle 100 (meaning that for conventional altitudes of the aerial vehicle 100, the interaction area remains substantially identical). For example, for a target located at sea, since the sea area is generally free of obstacles, the altitude of the aerial vehicle 100 does not substantially impact the size of the interaction area.

In some embodiments, altitude of the aerial vehicle 100 can impact the size of the interaction area. Indeed, in crowded areas (such as in a city), obstacles can be present between the line of sight of the payload 105 of the aerial vehicle flying at a given altitude, and the target. Assume that without any obstacles, the interaction area would have a radius R₁. In order to take into account that obstacles are present for an aerial vehicle 100 flying at this altitude, the interaction area can be voluntary reduced to have a radius R₂, with R₂<R₁. The coefficient of reduction can be determined e.g. using simulations (a simulation of the payload and of the crowded area including the target to be acquired can be performed), or can be predefined, or can be determined using e.g. heuristics.

According to some embodiments, determination of the interaction area for a target can be performed using the method of FIG. 4.

The method can include (operation 400) obtaining data informative of a position of the target at the period of time Tᵢ.

According to some embodiments, the target itself communicates its position. For example, for a sea target, the target can embed an automatic identification system (AIS). For a ground target, the target can embed e.g. a GPS system and a transponder for communicating its position. These examples are however not limitative.

According to some embodiments, the position of the target can be determined by the acquisition and/or tracking device 170 (e.g. a radar).

Note that position of the target can be either static (and in this case it is sufficient to determine this position once) or can evolve over time (and in this case this position needs to be determined periodically). The period at which this position needs to be determined depends in particular on the relative velocity of the target with respect to the aerial vehicle 100.

The method includes (operation 410) obtaining data informative of a dimension of the target. This data can include e.g. an estimated size of the target. In some embodiments, this data can include an estimated height, length and width of the target.

In some embodiments, the data informative of dimension of the target can be determined by the acquisition and/or tracking device 170. Generally, it is sufficient to acquire this data once. In some specific cases, the size of the target can evolve over time, and this data can be acquired periodically.

The method further includes (operation 420) using data informative of a position of the target and data informative of a dimension of the target to determine the interaction area of the target at the period of time Tᵢ.

According to some embodiments, the interaction area is a disk (the center of the disk corresponds to the position of the target at the period of time Tᵢ). The radius of the disk defines the maximal distance at which the payload 105 of the aerial vehicle 100 can be located from the target and can still be able to acquire the target. When the aerial vehicle 100 is located at the boundary of the interaction area (in the case of a disk, this corresponds to the perimeter of the disk), its payload 105 can still acquire the target. When the aerial vehicle 100 is located out of the interaction area, its payload 105 cannot acquire the target (even if some kind of acquisition is possible, even at long range, this acquisition will not meet the operability criterion).

Although the interaction area is depicted as a disk, in some embodiments, it can have another shape (for example because there is a forbidden area, or because of other constraints provided e.g. by an operator).

Note that the ability of the payload 105 to acquire the target depends mainly on the distance between the target and the aerial vehicle 100 and on the size of the target.

According to some embodiments, other parameters (such as weather conditions) which can influence the ability of the payload 105 to acquire the target, are neglected. In other embodiments, a model which models impact of the weather conditions on the ability of the payload to 105 to acquire the target can be used to determine the interaction area.

According to some embodiments, when the payload 105 is an acquisition device, the interaction area of each target is determined based on a maximal zoom-in capability of the acquisition device. The maximal zoom-in capability defines also the minimal field of view of the acquisition device.

For example, assume that the mission requires that each target has to be acquired by the acquisition device such that each target fills 20% of the size of the frame of the acquisition device.

If the target has a length of 100 m, a frame covering an area of 500 m is required (since 100/0.2=500).

If it is known that the minimal field of view of the acquisition device (as mentioned the minimal field of view and the maximal zoom-in capability are equivalent) is 1 degree (0.017 rad), this means that the radius of the interaction area for this target is 30 km (500/0.017≈30 km—the formula which can be used is e.g.: Length of the target/Field of view=Radius of the interaction area).

The use of the maximal zoom-in is not mandatory and other parameters can be used.

For example, if the payload 105 is a laser, the maximal effective distance of the laser can be used to determine the radius of the interaction area (the maximal effective distance is the maximal distance to the target for which the laser can perform an interaction with the target—above this distance the interaction cannot be performed by the laser, or the interaction does not he meet an operability criterion).

Reverting to FIG. 3, the method further includes generating (operation 310) a series of connections. Each connection comprises e.g. one or more segments (which can be in particular straight lines, but this is not mandatory, and they can comprise curved lines which connect the various interaction areas of the targets in order to define a flight path enabling acquisition of the targets by the payload 105 of the aerial vehicle 100.

In particular, each connection includes at least one waypoint located in an interaction area of a target of the plurality of targets, and at least one waypoint located in an interaction area of another different target of the plurality of targets.

For example, assume that a connection includes at least one waypoint located in an interaction area of a first target, and at least one waypoint located in an interaction area of a second target (different from the first target).

As a consequence, when the trajectory of the aerial vehicle 100 follows a path along this connection, its payload 105 will be able to acquire the first target and the second target.

According to some embodiments, each connection is an oriented connection (that is to say, it comprises a first waypoint corresponding to the starting point, and a second waypoint corresponding to the endpoint of the connection, the connection being oriented from the first waypoint to the second waypoint).

In order to be able to acquire all targets of the plurality of targets, each interaction area of each target of the plurality of targets includes a waypoint of at least one connection of the series of connections. In other words, the series of connections is such that each interaction area is intersected by at least one connection of the series, thereby enabling acquisition of all targets by the payload 105 of the aerial vehicle 100.

As explained hereinafter, according to some embodiments, the series of connections is generated progressively (by connecting the various targets progressively) by testing various alternatives so as to meet an optimization criterion.

Once the series of connections has been generated, a flight path FPi is obtained (operation 320), which corresponds to the union of this series of connections.

According to some embodiments, operations 300, 310 and 320 are performed during a flight of the aerial vehicle.

If at least one target of the plurality of targets is a moving target, then the flight path FPᵢ can be updated over time, to take into account this evolution.

This is illustrated in FIG. 3, in which, for a period of time Tᵢ₊₁ (different from the period of time Tᵢ—note that Tᵢ₊₁ occurs after Tᵢ), operations 300, 310 and 320 are repeated, to generate an updated flight path FPᵢ₊₁.

At the period of time Tᵢ₊₁, the position of the aerial vehicle 100 and of the one or more moving targets has changed. The position of the static targets has not changed. Therefore, a different series of connections is obtained at iteration i+1, which is used to generate a different flight path FPᵢ₊₁ for time Tᵢ₊₁.

Note that according to some embodiments, at each iteration “i”, generating the series of connections can rely on an assumption that the targets are all static (until update of the flight path at iteration “i+1”).

For example, assume that the area 250 in which the targets are located has a dimension of X (e.g. length of X). Assume that during the period of time “Tᵢ₊₁−Tᵢ”, the distance traveled by each moving target 200 of the plurality of targets is Dⱼ (this can be calculated using the velocity of each moving target), and Dⱼ can be ignored with respect to X (|Dⱼ/X|≤threshold T−the threshold T for which Dⱼ can be selected with respect to X can be set e.g. by an operator). In a non-limitative example, assume that X is equal to 200 km and D is equal to 2 km, the threshold can be set as T=D/X=2/200=0.01 (this value is not limitative). In this example, generation of the connections at each iteration “i” can rely on the assumption that each target is static.

According to some embodiments, the velocity of the moving target(s) is not known or not measured. At each iteration of the method, each target can be modelled as static. In some embodiments, the frequency of update of the flight path can be increased to take into account the fact that one or moving target(s) may have a velocity which cannot be ignored with respect to the dimension of the area 250 to be covered by the aerial vehicle 100.

According to some embodiments, the frequency of update (F) can be determined using the following formula (this formula is not limitative): F=D/target speed. D can be obtained as follows: D=T·X (with T the threshold as defined above and X the size of the area as defined above). The “target speed” corresponds to the speed of the target which is to be handled. In some embodiments, if a plurality of moving targets is to be handled within the area, the following equation can be used: F=D/max speed, wherein max speed is the maximal speed of the plurality of moving targets that need to be handled.

According to some embodiments, at a given period of time, the flight path is determined for all targets (although, in practice, the flight path will be updated before the aerial vehicle will interact with all targets) since this information can be useful to provide indications such as current estimated time to interact with all targets during the mission, amount of fuel required to perform the whole mission, etc. In some embodiments, the flight path is determined only for some of the targets.

According to some embodiments, and as explained hereinafter, at each iteration of the method, the velocity of the moving target(s) can be taken into account to generate the flight path.

According to some embodiments, when the aerial vehicle 100 is located in an interaction area of a given target of the plurality of targets, it can automatically provide information on the target which is pertinent for the mission. For example, assume that the payload 105 is an acquisition device and that the target is a marine target (this is not limitative). The aerial vehicle 100 can determine whether data of the marine target (e.g. size, name, flag, which can be determined based on an image of the marine target acquired by the payload 105) matches data provided by an AIS of the marine target. If the aerial vehicle 100 fails to automatically identify the marine target, the method can include entering a mode in which the aerial vehicle 100 is forced to fly towards the target. Then, an operator, located e.g. at the remote control unit 160, attempts to manually identify the target based on images acquired by the payload 105 of the aerial vehicle 100. Once the aerial vehicle 100 has been identified, the aerial vehicle 100 can return to an automatic mode (the flight path can be updated based on the last position of the aerial vehicle 100, using e.g. the method of FIG. 3).

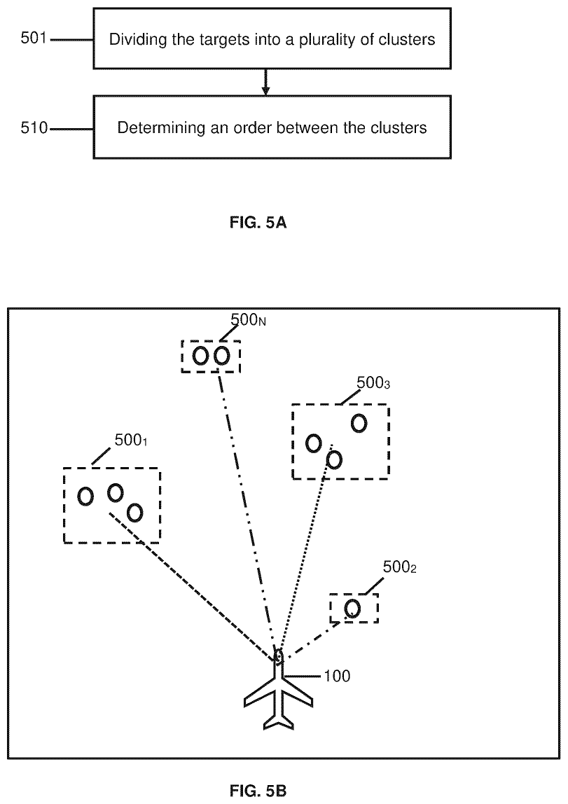

Attention is now drawn to FIGS. 5A and 5B.

According to some embodiments, in order to generate the series of connections (see operation 310), the method comprises a preliminary operation 501 of dividing the plurality of targets into a plurality of clusters (500₁, 500₂, . . . ,500_{N}). At least one cluster of the plurality of clusters includes at least two targets. The other clusters can include one target or a plurality of targets.

The division into clusters can depend on a distribution of distance between the targets. For example, targets belonging to the same given cluster are such that the distance inter-targets within this given cluster is (e.g. on average) lower than the distance between targets of this given cluster to other targets belonging to other clusters. In some embodiments, a size of the area 250 can be taken into account.

Division into clusters can use e.g. clustering algorithms such as K-means, Mean-Shift Clustering, DBSCAN (Density-Based Spatial Clustering of Applications with Noise), EMGMM (Expectation-Maximization Algorithm for Gaussian mixture model), HAC (hierarchical agglomerative clustering), etc.

Once the clusters have been determined, an order (operation 510) between the clusters can be determined. For example, the order can indicate that the flight path of the aerial vehicle 100 should first go to cluster 2 and then to cluster 1, up to cluster N.

Note that according to some embodiments, the clusters and/or the order between the clusters can evolve over time, since one or more targets can be a moving target. Therefore, at each time Tᵢ, operations 501 and 510 can be repeated.

Various criteria can be used to determine the order between the clusters. In some embodiments, a score can be attributed to each cluster based on the various criteria, and, based on this score, the order between the clusters can be determined (for example, the higher the score of a given cluster, the higher the probability that this given cluster corresponds to the first cluster).

According to some embodiments, a distance between a center of mass of each cluster and an initial position from which the flight path is to be generated (e.g. position of the aerial vehicle 100 at the period of time Tᵢ) is used to determine the order. The center of mass can correspond e.g. to a centroid/center of gravity determined as an average of all positions of the targets within the cluster. In the example of FIG. 5B, according to this criterion, a higher score is attributed to cluster 500₂ in order to be considered as the first cluster. The next cluster can be selected by determining the cluster whose center of mass is the closest to the center of mass of the first cluster. The method can be repeated iteratively for all clusters.

According to some embodiments, a number of targets in each cluster is taken into account. The larger this number for a cluster, the higher the score attributed to this cluster. Therefore, this cluster will have a higher chance to be among the first clusters in the order. This reflects the fact that a cluster including a larger number of targets is of higher interest than a cluster with a lower number of targets, and therefore should be located beforehand along the flight path.

According to some embodiments, assume that each target is assigned with a level of priority. The level of priority indicates to which extent acquisition of the target is important in the mission of the aerial vehicle 100 (or, more generally, it reflects importance of interaction with the target). For example, a high level of priority indicates that acquisition of the target is of high importance.

An aggregated level of priority can be computed for each cluster. For example, this aggregated level of priority can be computed as an average of all levels of priority of all targets within the cluster. This is however not limitative.

Therefore, the aggregated level of priority of each cluster can be taken into account when determining the order between the clusters. The higher the aggregated level of priority of a cluster, the higher the score attributed to this cluster. Therefore, this cluster will have a higher chance to be among the first clusters in the order.

Based on one or more of the criteria discussed above (and/or additional/different criteria), the order between the clusters can be determined.

According to some embodiments, the score based on which the order between the clusters is determined can be calculated using the formula (this formula is not limitative):

Scorecₗᵤₛₜₑᵣ=(ClusterAveragePriority*ClusterNumofTargets)/(ClusterDistance)

In this formula, Score_{cluster} is the score of a given cluster, ClusterAveragePriority is the aggregated level of priority of the targets of the given cluster (as explained above), ClusterNumofTargets is the number of targets of the given cluster (as explained above) and ClusterDistance is the distance to the given cluster (as explained above).

Note that the order between the clusters can evolve over time. Similarly, division of the targets into clusters can evolve over time. Therefore, according to some embodiments, the division into clusters and the determination of the order between the clusters is repeated at each period of time (Tᵢ, Tᵢ₊₁, etc.).

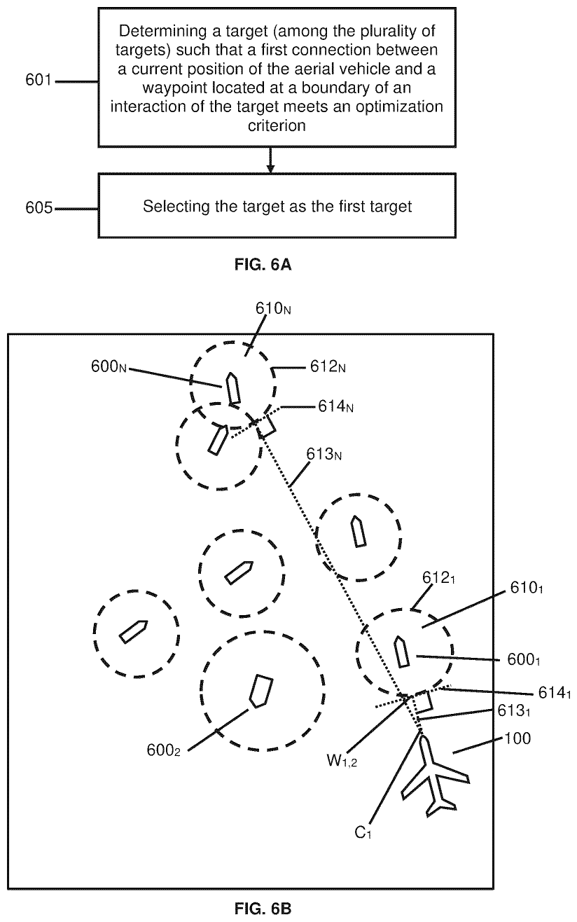

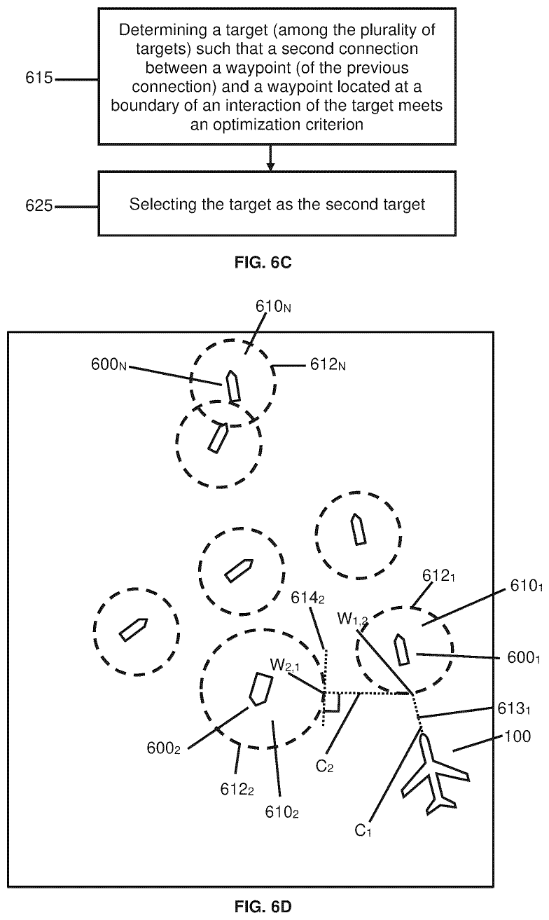

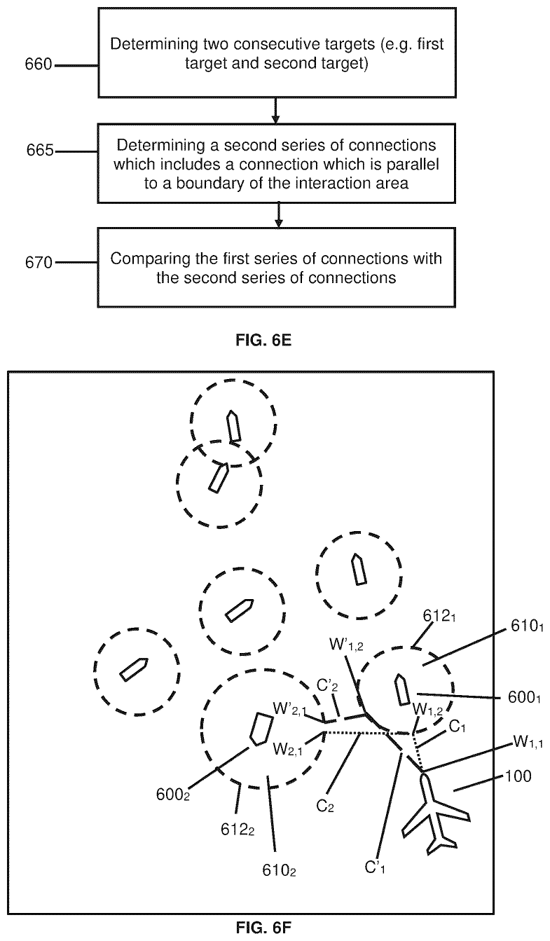

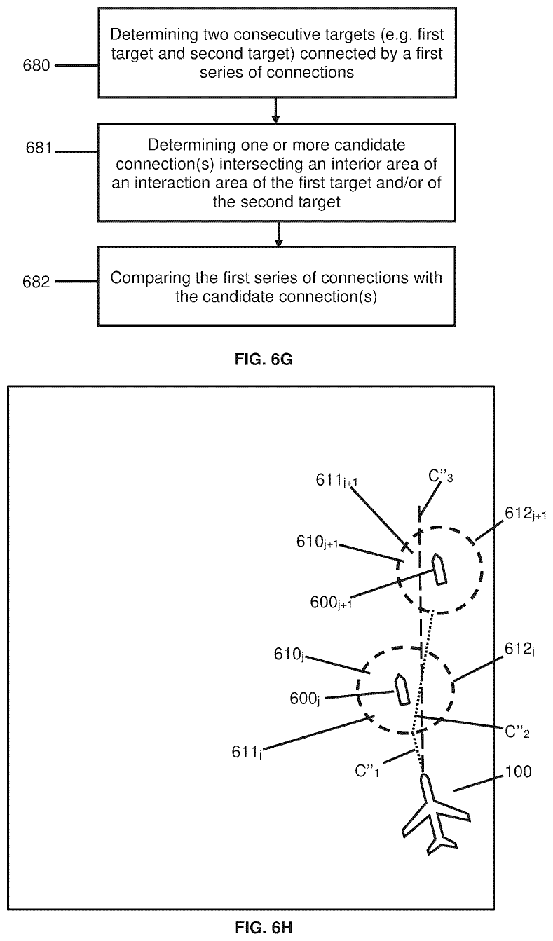

Attention is now drawn to FIG. 6A, which depicts operations which can be performed in order to generate the series of connections (see operation 310 in FIG. 3).

The method can include determining (operation 601), among the plurality of targets, a target which is the first target to be acquired by the aerial vehicle 100 along its flight path.

Operation 601 can include determining a connection which includes the current position of the aerial vehicle 100 (at time Tᵢ) and a waypoint located e.g. at the boundary of an interaction area of a target, such that this connection meets an optimization criterion. According to some embodiments, the connection is selected to be orthogonal to a tangent of the boundary of the interaction area of the target (at this waypoint).

According to some embodiments, the optimization criterion takes into account the length of the connection. In other words, the target for which the connection has the smallest length has the highest probability to be selected as the first target. Note that the connection can be a straight line. This is however not mandatory, because in some embodiments, there can be one or more forbidden areas (a forbidden area is an area in which it is forbidden for the aerial vehicle to enter). As a consequence, the connection can include various pieces of connected straight lines, or one or more curved portions enabling bypass of the forbidden area(s).

According to some embodiments, the optimization criterion takes into account (in addition to, or in place of the length of the connection) the level of priority of each target. In other words, it is possible that a target which is located farther than another target with respect to the current position of the aerial vehicle, will be selected as the first target because it has a higher level of priority, although the length of the connection to reach the interaction area of this target is larger.

According to some embodiments, the optimization criterion takes into account both the length of the connection to the target and the level of priority of the target.

An example is provided with reference to FIG. 6B.

Assume that the area includes targets 600₁ to 600_{N}, associated with interaction areas 610₁ to 610_{N} (each interaction area 610₁ to 610_{N} has a boundary 612₁ to 612_{N}).

According to some embodiments, a plurality of candidate connections 613₁ to 613_{N} is generated (operation 601 in FIG. 6A): each candidate connection is a line (e.g. a straight line, since this enables reducing the length of the flight path—as mentioned above, in some embodiments, a connection can include curved portions to bypass forbidden areas(s)) between the current position of the aerial vehicle 100 at time Tᵢ and a waypoint located at a boundary (612₁ to 612_{N}) of a given interaction area of a given target. For each given target, the candidate connection (613₁ to 613_{N}) is orthogonal to a tangent (614₁ to 614_{N}) to a boundary (612₁ to 612_{N}) of the given interaction area of the given target.

A plurality of candidate connections 620₁ to 620_{N} is obtained (in order to simplify presentation of FIG. 6A, only two candidate connections 620₁ and 620_{N} are depicted in FIG. 6).

Based on the candidate connections, a first target is selected.

Assume for example that the optimization criterion takes into account only the length of the connection. As a consequence, in the example of FIG. 6A, target 600₁ is selected as the first target (for time Tᵢ). Therefore, a first connection C₁ is obtained which joins the current position of the aerial vehicle 100 at time Tᵢ to the waypoint W_{1,2} located at the boundary of the interaction area of the first target 600₁.

According to some embodiments, the targets are divided into clusters (see FIG. 5A) and an order between the clusters has been determined. In this case, the method of FIG. 6A is performed for the first cluster: it is attempted to determine the first target in the first cluster.

According to some embodiments, if the targets have been divided into a plurality of clusters, a flight path can be first generated for the targets of the first cluster. In some embodiments, the order between the targets of the first cluster is selected according to a decreasing distance with respect to the next cluster (e.g. center of mass of the second cluster).

For example, the target which is selected as the first target of the flight path within the first cluster is the target which has the highest distance to the next cluster (in this case the second cluster).

The target which is selected as the second target of the flight path within the first cluster is the target which has the second highest distance to the next cluster (in this case the second cluster).

The last target of the flight path within the first cluster is the target which is the closest to the second cluster. This enables to have a transition between each cluster and the consecutive cluster with the smallest travelling distance.

In some embodiments, the level of priority of the targets can be also taken into account to determine the order between the targets within each cluster.

This process can be repeated similarly for each cluster.

For the last cluster, since there is no next cluster, the targets are ordered according to the smallest distance with respect to the current position on the flight path.

The method described above is not limitative, and in some embodiments, for each cluster, the targets are ordered according to the smallest distance with respect to the current position on the flight path.

Attention is drawn to FIG. 6C.

Once the first target has been identified, the method can include determining the second target of the flight path.

According to some embodiments, the method of FIG. 6C (see operations 615 and 625) can rely on the same method as described with reference to FIGS. 6A and 6C.

The difference is that the starting point is not the current position of the aerial vehicle 100 at time Tᵢ, but rather the waypoint C_{1,2} corresponding to the extremity of the previous connection C₁ (determined in the method of FIG. 6A).

The method includes determining a second target, for which a second candidate connection C₂ meets an optimization criterion. The second candidate connection C₂ comprises the waypoint W_{1,2} (determined at the previous iteration of the method) and a waypoint W_{2,1} located at a boundary of the interaction area of the second target. The second candidate connection C₂ is orthogonal to a tangent to the boundary of the interaction area of the second target (at the waypoint W_{2,1}).

As explained with reference to FIGS. 6A and 6B, a plurality of candidate connections can be “tested” and the candidate connection which meets the best the optimization criterion can be selected as the second candidate connection C₂.

In the example of FIG. 6D, the second target is selected as target 600₂. The second connection C₂ includes the waypoint W_{1,2} and the waypoint W_{2,1}. The second connection C₂ is orthogonal to a tangent 614₂ to the boundary 612₂ of the interaction area 610₂ of the second target 600₂ (at the waypoint W_{2,1}).

The method of FIG. 6C can be repeated to select a third target (a connection is generated between the waypoint located at the extremity of the connection determined at the previous iteration and the interaction area of the third target), etc. until the series of connections (operation 310) is generated.

According to some embodiments, and as explained hereinafter, different types of connections can be tested (e.g. which are not necessarily orthogonal to a tangent to a boundary of an interaction area of the target), in order to further improve generation of the series of connections.

Attention is now drawn to FIGS. 6E and 6F.

According to some embodiments, once at least two consecutive targets (noted as first target and second target—note that these two targets are not necessarily the two first targets within the flight path and can correspond to any of two consecutive targets within the flight path) have been identified (see operation 660), different types of connections can be tested.

Assume (see operation 665) that a first series of connections comprising a first connection C₁ and a second connection C₂ have been obtained (as explained above).

The first connection C₁ comprises a waypoint W_{1,1} (corresponding e.g. to the current position of the aerial vehicle 100 at time Tᵢ—or corresponding to the extremity of the previous connection which connects the interaction area of the previous target to the interaction area of the first target), and a waypoint W_{1,2}, wherein the first connection C₁ is orthogonal to a tangent to a boundary 612₁ of an interaction area 610₁ of the first target 600₁.

The second connection C₂ comprises the waypoint W_{1,2} corresponding to the extremity of the previous connection, and a waypoint W_{2,1}, wherein the second connection C₂ is orthogonal to a tangent to a boundary 612₂ of an interaction area 610₂ of the second target 600₂.

The method comprises generating a second series of connections (operation 665).

The second series of connections comprises a first candidate connection C′₁ comprising the waypoint W_{1,1} and a waypoint W′_{1,2} located at a boundary of the interaction area 610₁ of the first target 600₁, wherein the first candidate connection C′₁ is tangent to the boundary of the interaction area 610₁ of the first target 600₁ at said waypoint W′_{1,2}.

The second series of connections comprises a second candidate connection C′₂, which comprises the waypoint W′_{1,2} and another waypoint W′_{2,1} located at the boundary of the interaction area 610₂ of the second target 600₂, wherein the second candidate connection C′₂ is orthogonal to a tangent of the interaction area 610₂ of the second target 600₂.

In other words, instead of requiring the aerial vehicle 100 to fly along a flight path orthogonal to the boundary of the interaction area of the first target, an approach in which the flight path is tangent to the boundary of the interaction area of the first target is evaluated.

According to some embodiments, the method comprises comparing (operation 670) the first series of connections with the second series of connections. According to some embodiments, if the length of the second series of connections is smaller than the length of the first series of connections, the method can include using the second series of connections when generating the series of connections, instead of the first series of connections.

In other words, it is tested whether the approach in which the flight path is tangent to the boundary of the interaction area of the first target is more optimal than an approach orthogonal to the tangent to the boundary of the first interaction area.

Attention is now drawn to FIGS. 6G and 6H.

Assume that during generation of the series of connections for a given period of time Tᵢ (using e.g. one of the methods described above—as mentioned above, generation of the series of connections is performed progressively, by identifying progressively the next target to be reached), it has been determined that target 600ⱼ₊₁ should be consecutive to target 600ⱼ in the flight path. In other words, the series of connections requires that the aerial vehicle 100 first interacts with target 600ⱼ and then with target 600ⱼ₊₁ (operation 680).

Assume for example that a first series of connections including connections C″₁ and C″₂ have been determined (see FIG. 6H): the aerial vehicle 100 is required to first follow connection C″₁ to acquire target 600 and then to follow connection C″₂ to acquire target 600ⱼ₊₁. In this non-limitative example, C″₁ is orthogonal to a tangent to a boundary of the interaction area 610ⱼ of target 600ⱼ and C″₂ is orthogonal to a tangent to a boundary of the interaction area 610ⱼ₊₁ of target 600ⱼ₊₁. This is however not limitative.

The interaction area 610ⱼ comprises a boundary 612ⱼ (perimeter of the disk) and an interior area 611ⱼ (interior of the disk, excluding the perimeter).

Similarly, the interaction area 610ⱼ₊₁ comprises a boundary 612ⱼ₊₁ (perimeter of the disk) and an interior area 611ⱼ₊₁ (interior of the disk, excluding the perimeter).

As mentioned above, various types of connections can be tested (e.g. orthogonal to the boundary of the interaction area, tangent to the boundary of the interaction area, etc.).

The method comprises determining (681) a candidate connection which intersects an interior area of the interaction area of the first target and/or an interior area of the interaction area of the second target. In other words, it is tested whether flying directly through the interior area of the respective interaction areas provides a shorter flight path (than the flight path previously generated).

In the non-limitative example of FIG. 6H, candidate connection C″₃ is generated, which intersects both the interior area 611ⱼ of the interaction area 610ⱼ of the first target 600ⱼ and the interior area 611ⱼ₊₁ of the interaction area 610ⱼ₊₁ of the second target 600ⱼ₊₁. In this example, the candidate connection C″₃ is a straight line, but this is not mandatory, and other types of lines can be used (e.g. two connected straight lines which are not parallel, a curved line, etc.).

The candidate connection is compared to the connection(s) previously determined (in particular, a comparison of their respective length is performed). In the example of FIG. 6H, the length of candidate connection C″₃ is compared to the total length of connections C″₁ and C″₂. In this particular example, it appears that connection C″3 is shorter than the sum of C″₁ and C″₂ and therefore should be selected for generating the series of connections.

Although the example of FIG. 6H has been depicted with two targets, the method can be used for N targets, with N>2. Assume for example that a series of connections has been determined for these N targets (the series of connections follows an order determined between the N targets). It can be tested whether a straight line intersecting the interior area of the interaction of each of the N targets (or of at least a subset of the targets) is shorter than the series of connections previously determined.

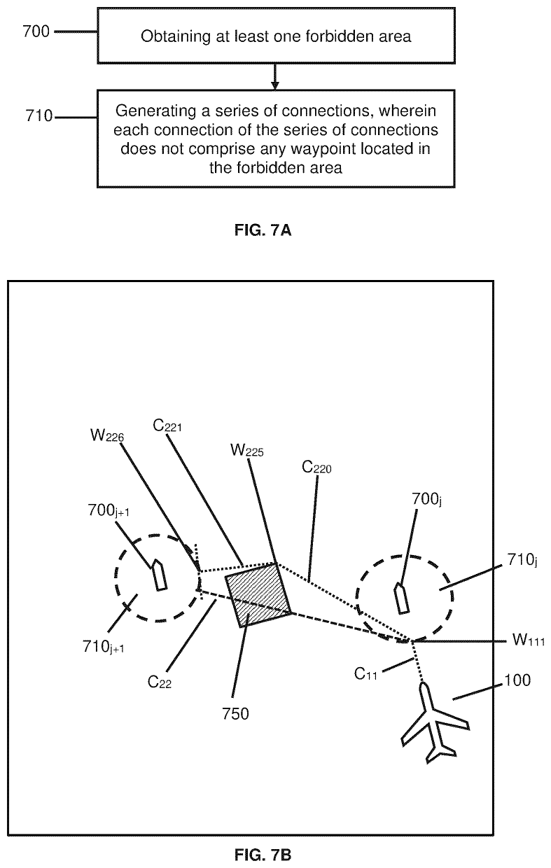

Attention is now drawn to FIG. 7A.

According to some embodiments, the method includes obtaining (operation 700) at least one forbidden area 704. A forbidden area is an area in which it is forbidden for the aerial vehicle 100 to enter (due e.g. to regulations, tactical reasons, etc.). The forbidden area can include e.g. a series of waypoints defined by their latitude and longitude (and, if necessary, altitude).

The method includes generating (operation 710) a series of connections (using the various embodiments described above), wherein each connection of the series of connections does not comprise any waypoint located in the forbidden area(s) 704. In other words, a flight path which bypasses the forbidden area(s) is built.

Generating a connection between two interaction areas of two different targets which avoids at least one forbidden area can rely on various methods. In some embodiments, the method described in the U.S. patent application Ser. No. 16/892,726 of the Applicant (content of this patent application is incorporated hereinafter in its entirety) can be used. This is however not limitative, and other methods can be used.

FIG. 7B illustrates a non-limitative example of the method of FIG. 7A. Assume that it is attempted to generate a connection between an interaction area 710ⱼ of target 700ⱼ and an interaction area 710ⱼ₊₁ of target 700ⱼ₊₁.

A first connection C₁₁ is generated between the current position of the aerial vehicle 100 (at time Tᵢ) and a waypoint C₁₁₁ located at a boundary of the interaction area 710ⱼ of target 700ⱼ.

If there is no forbidden area, and the method of FIG. 6C and FIG. 6D is used, then the second connection should correspond to connection C₂₂ depicted in FIG. 7A (C₂₂ includes waypoint W₁₁₁ and is orthogonal to a tangent to a boundary of the interaction area 710ⱼ₊₁ of target 700ⱼ₊₁). However, since a forbidden area 750 is present, different connections must be generated. In the non-limitative example of FIG. 7B, a connection C₂₂₀ is generated which joins the waypoint W₁₁₁ to a waypoint W₂₂₅ located at a vertex of the polygon representative of the forbidden area 750 (as shown, according to some embodiments, the method strives to keep the connections which bypass the forbidden area 750 as close as possible to the forbidden area 750, in order to minimize the length of the flight path). An additional connection C₂₂₁ is generated, which joins the endpoint W₂₂₅ of the connection C₂₂₀ to a waypoint W₂₂₆ located at a boundary of the interaction area 710ⱼ₊₁ of the target 700ⱼ₊₁.

Note that the connection C₂₂₀ is orthogonal to a tangent to the boundary of the interaction area 710ⱼ₊₁ of the target 700ⱼ₊₁, in compliance with the method of FIG. 6C and FIG. 6D. This is however not mandatory.

Although in the example of FIG. 7B, two straight lines are generated to bypass the forbidden area, this is not limitative, and in other embodiments, curved lines can be generated.

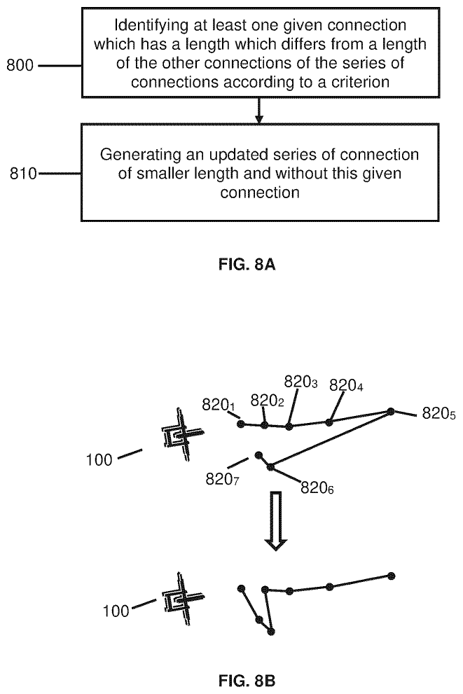

Attention is now drawn to FIG. 8A.

Assume that for given period of time Tᵢ, a series of connections have been determined.

The method of FIG. 8A includes identifying (operation 800) at least one given connection which has a length which differs from a length of the other connections of the series of connections according to a criterion. For example, the length of each connection is compared to the average length of all connections, and it is detected whether the difference between a length of a given connection and this average length is larger than a threshold (the criterion can define e.g. this threshold).

As a consequence, the method includes generating (operation 810) an updated series of connections. In particular, this updated series of connections does not comprise the given connection (identified as irregular because of its excessive length). In addition, the updated series of connections is selected to have a total length which is smaller than the total length of the original series of connections. In some embodiments, operation 810 comprises reusing the same waypoints, but connected in a different manner (using different connections—the waypoints can be connected in a different order).

A non-limitative example is provided in FIG. 8B.

Assume that a series of connections have been generated. Each connection defines the flight path between a starting waypoint and an ending waypoint (see waypoints 800₁ to 800_{N}). In this non-limitative example, the connections are substantially straight lines. The flight path starts from waypoint 800₁ and ends at waypoint 800₇.

The average length of the connections depicted in the upper part of FIG. 8A is determined. The length of the connection which joins waypoint 820₅ to waypoint 820₆ differs from the average length more than the threshold (defined e.g. by an operator).

As a consequence, it is attempted to generate an updated series of connections. According to some embodiments, the updated series of connections (see bottom part of FIG. 8B) comprises the same waypoints 820₁ to 820₇ but which are connected in a different manner. In particular, it is checked whether given waypoints belonging to the given connection identified as irregular (and also other waypoints which are in the vicinity of these given waypoints) can be connected to waypoint(s) which is(are) closer to them. In the present example, this induces generation of a new connection between waypoint 802₆ and 820₂ and of a new connection between waypoints 802₁ and 820₇. The total length of the updated series of connections (see below part of FIG. 8B) is reduced with respect to the total length of the original series of connections (see top part of FIG. 8B). The order between the waypoints has been changed: the flight path goes successively through waypoints 820₁, 820₇, 820₆, 820₂, 820₃, 820₄ and 820₅.

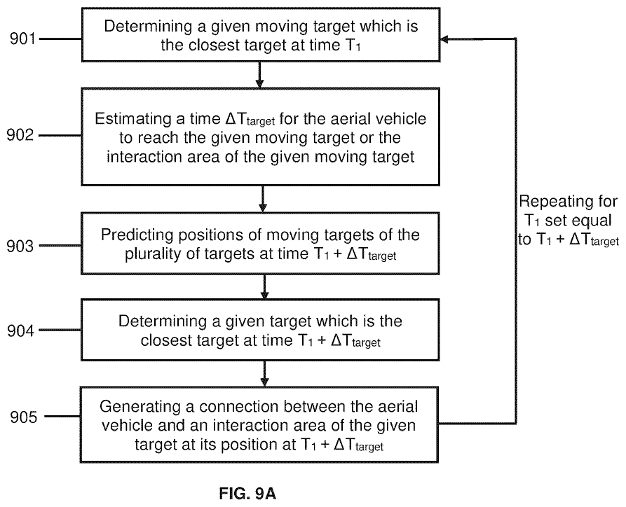

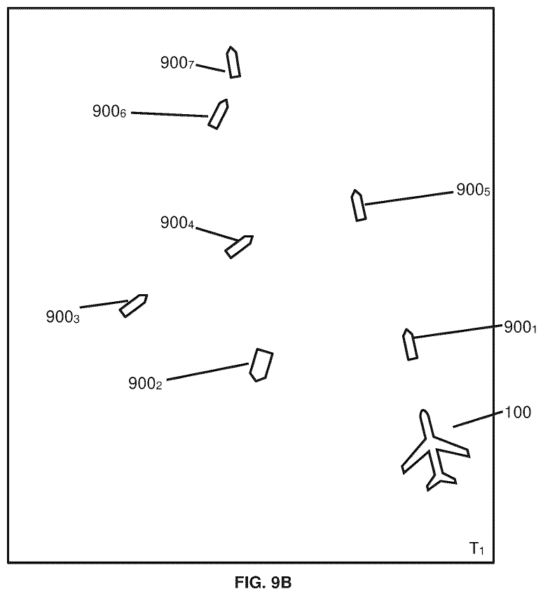

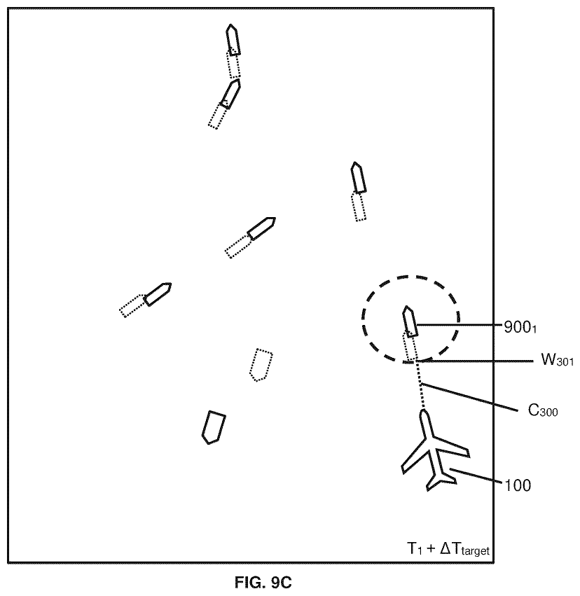

Attention is now drawn to FIGS. 9A and 9B.

According to some embodiments, the displacement of one or more moving target(s) can be taken into account to generate the series of connections.

Assume that the position of the aerial vehicle 100 and of the targets is known at the period of time T₁ (see a non-limitative example of a map of the targets 900₁ to 900₇ at time T₁ in FIG. 9B). In addition, velocity of the aerial vehicle can be obtained at T₁. In some embodiments, velocity of the moving target(s) is obtained at T₁ (using e.g. device 170, or other ways enabling obtaining this velocity).

According to some embodiments, it can be determined (operation 901) that a given target among the plurality of targets meets a criterion. According to some embodiments, the given target meets the criterion if the distance between the position of the aerial vehicle 100 at time T₁ and the position of the given target at time T₁ is the smallest relative to all other targets. In some embodiments, the criterion can take into account the level of priority of each target, and the given target is the one which has the highest score, wherein the score depends on the distance between the aerial vehicle 100 and the given target (the lower the distance, the higher the score), and the level of priority of the given target (the higher the level of priority, the higher the score).

For example, in FIG. 9B, target 900₁ is the target which is the closest to the aerial vehicle 100.

The method further comprises estimating (operation 902) the period of time ΔT_{target} required by the aerial vehicle 100 to reach the given target (or to reach the interaction area of the target). According to some embodiments, this estimation can be performed by assuming that the aerial vehicle 100 follows e.g. a straight line (if there is a forbidden area, then the method determines a path which avoids this forbidden area, as explained above). This can be determined since the initial position and the velocity of the aerial vehicle 100 at time T₁ are known (it can be e.g. assumed that there is a constant velocity to reach the target or its interaction area), and the trajectory of each target can be predicted over time. The trajectory of each target can be predicted over time using e.g. tracking information of the device 100 (which is e.g. a radar—since the target is tracked over a period of time, its future motion can be predicted using e.g. Kalman filtering), and/or using velocity information of the target (measured by the device 100, or provided by the target itself, or by a third party).

Once ΔT_{target} has been determined, the position of all targets is predicted at time T₁+ΔT_{target}.

Prediction of the position of the targets at a future time can be performed using various methods.

According to some embodiments, since each target can be tracked by the device 170 (e.g. a radar), a track can be generated for each target, and therefore the future position of each target can be predicted (using e.g. Kalman filters or other techniques of the art). Regarding targets which are static, their positions remain the same between T₁ and T₁+ΔT_{target}.

FIG. 9C depicts positions of the targets as predicted at future time T₁+ΔT_{target}, and also depicts, in a dotted line, previous positions of the targets at time T₁.

At operation 904, it is verified again (at predicted time T₁+ΔT_{target}) whether the given target (as identified at operation 901) is still the target which is the closest to the position of the aerial vehicle 100 at time T₁ (or whether the interaction area of the given target is the closest to the position of the aerial vehicle 100). Indeed, since some targets are moving towards the aerial vehicle 100, and some are moving away from the aerial vehicle 100, it can occur that a different target is the closest target at time T₁+ΔT_{target}.

In some embodiments, at time T₁+ΔT_{target}, both the distance to the aerial vehicle and the level of priority of each target is taken into account to select the target at operation 904.

In the example of FIGS. 9B and 9B, target 900₁ is the closest target both at time T₁ and at time T₁+ΔT_{target}.

The method further includes determining an interaction area of the target selected at operation 904 (in the example of FIGS. 9B and 9C, this corresponds to target 900₁).

Since the position of the selected target at time T₁+ΔT_{target} has been predicted, and the dimension of the selected target is known, the interaction area of the selected target located at its predicted position can be determined (using e.g. the method of FIG. 4).

The method further includes determining a connection C₃₀₀ between the position of the aerial vehicle 100 and a waypoint W₃₀₁ located in the interaction area of the selected target (in the example of FIG. 9C, this corresponds to target 900₁).

The method of FIG. 9A can be repeated iteratively to generate the flight path covering all targets (for the position of the aerial vehicle at time T₁).

The waypoint W₃₀₁ is considered as the starting point, and it is determined which given target is the closest target to W₃₀₁.

The time of travel ΔT_{target,2} from W₃₀₁ to this given target is estimated. The positions of all targets are predicted at time T₁+ΔT_{target}+ΔT_{target,2}. It is verified whether the given target is still the closest target to W₃₀₁. If this is the case, a connection is determined between W₃₀₁ and an interaction area of this given target.

The method can be repeated until the flight path is generated such that it enables acquisition of all targets. Therefore, for time T₁, a complete flight path FP₁ is obtained. As mentioned, in some embodiments, the flight path is updated before the aerial vehicle manages to cover all targets, but the complete flight path FP1 is useful to provide indications about estimate time to perform the mission, required fuel, etc.

Over time (e.g. at time T₂ different from T₁), the method of FIG. 9A can be repeated (using a map including position of the aerial vehicle 100 and the targets at time T₂), in order to generate an updated flight path at time T₂.

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1-46. (canceled)

47. A system comprising one or more processing circuitries, configured to, for an aerial vehicle comprising a payload operative to perform an interaction with a target:
for each target of a plurality of targets, determine an interaction area based on a position of the target,
wherein, for each position of the aerial vehicle located in the interaction area of the target, the interaction between the payload and the target is enabled according to an operability criterion,
divide the plurality of targets into a plurality of clusters, wherein at least one cluster comprises at least two targets of the plurality of targets, wherein said dividing is based on a distribution of distance between the targets,
determine an order between the plurality of clusters,
generate a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections, and
obtain a flight path for the aerial vehicle using the series of connections, wherein said flight path follows said order between the plurality of clusters.

48. The system of claim 47, configured to, during a flight of the aerial vehicle:
(1) for a period of time Ti of the flight of the aerial vehicle:
for each target of a plurality of targets, obtain an interaction area based on a position of the target at the period of time Ti,
wherein, for each position of the aerial vehicle located in the interaction area of the target, the interaction between the payload and the target is enabled according to an operability criterion,
wherein at least one target of the plurality of targets is a moving target, generate a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections,
obtain a flight path FPi for the aerial vehicle using the series of connections,
(2) repeating (1) at least once for a period of time Ti+1 different from Ti, wherein the moving target has a position at time Ti+1 different from time Ti, to generate an updated flight path FPi+1 for the aerial vehicle.

49. The system of claim 47, wherein at least one of (i) or (ii) is met:
(i) the payload comprises an acquisition device and the interaction with the target comprises an acquisition of the target by the acquisition device;
(ii) the payload comprises an acquisition device and the interaction with the target comprises an acquisition of the target by the acquisition device, wherein the interaction area of each target is determined based on a maximal zoom-in capability of the acquisition device.

50. The system of claim 47, wherein generating the series of connections comprises determining a connection between a waypoint of a given connection of the series of connections and an interaction area of a next target, said determining comprising selecting the connection among one of:
(i) a connection which comprises the waypoint and is orthogonal to a tangent to a boundary of the interaction area of the next target;
(ii) a connection which comprises the waypoint and is tangent to the boundary of the interaction area of the next target;
(iii) a connection which intersects an interior area of the interaction area of the next target.

51. The system of claim 47, wherein, for at least one given target of the plurality of targets associated with a given interaction area, a given connection of the series of connections comprises a waypoint located at a boundary of said given interaction area, said waypoint having a position different from a position of the given target.

52. The system of claim 47, wherein generating the series of connections comprises generating a connection from a starting waypoint, said generating comprising:
determining a first target among the plurality of targets, for which a first candidate connection C1 meets an optimization criterion, wherein the first candidate connection C1 comprises a first waypoint W1,1 corresponding to the starting waypoint, and a second waypoint C1,2 located at a boundary of an interaction area of the first target, wherein the first candidate connection C1 is orthogonal to said boundary.

53. The system of claim 28, wherein the optimization criterion takes into account at least one of:
(i) a length of the first candidate connection C1; and
(ii) a level of priority of the first target.

54. The system of claim 51, configured to:
determine a second target among the plurality of targets, for which a second candidate connection C2 comprising the second waypoint W1,2 and a third waypoint W2,1 located at a boundary of an interaction area of the second target, meets an optimization criterion, wherein the second candidate connection C2 is orthogonal to said boundary,
after identification of the first target and the second target:
perform a comparison between:
a first series of connections comprising the first candidate connection C1 and the second candidate connection C2, and
a second series of connections comprising a first candidate connection C′1 comprising the first waypoint C1,1 and a second waypoint W′1,2 located at a boundary of the interaction area of the first target, wherein the first candidate connection C′1 is tangent to the boundary of the interaction area of the first target at said second waypoint W′1,2,
generate the series of connections based on the comparison.

55. The system of claim 47, wherein generating the series of connections comprises:
determining an order among targets of the plurality of targets for generating the series of connections, wherein a second target is consecutive to a first target according to said order, and
determining a candidate connection which intersects at least one of:
an interior area of an interaction area of the first target, and
an interior area of an interaction area of the second target,
using said candidate connection for generating the series of connections.

56. The system of claim 47, configured to:
obtain at least one forbidden area, and
generate the series of connections, wherein each connection of the series of connections does not comprise any waypoint located in the forbidden area.

57. The system of claim 47, wherein determining the order between the plurality of clusters uses at least one of:
(i) a distance between a center of mass of each cluster and an initial position from which the flight path is to be generated;
(ii) a number of targets of each cluster;
(iii) data informative of a level of priority of the one or more targets of each cluster.

58. The system of claim 47, configured to, for at least one given cluster of the plurality of clusters:
determine an order between targets of the given cluster according to a decreasing distance with respect to a next cluster being after said given cluster,
generate the flight path, wherein said flight path follows said order between the targets of the given cluster.

59. The system of claim 47, configured to:
identify at least one given connection which has a length which differs from a length of other connections of the series of connections according to a criterion,
generate an updated series of connections, which:
(i) does not comprise said given connection, and
(ii) has a length which is smaller than a length of the series of connections.

60. The system of claim 47, wherein, for each target:
(i) for each position of the aerial vehicle located in the interaction area of said target, the interaction between the payload and said target is enabled according to the operability criterion, and
(ii) for each position of the aerial vehicle located outside the given interaction area, the interaction between the payload and the given target is not enabled according to the operability criterion.

61. The system of claim 47, configured to, for at least one target of the plurality of targets:
obtain data informative of a position of the target and data informative of a dimension of the target,
use the data informative of a position of the target and the data informative of a dimension of the target to determine the interaction area of the target.

62. The system of claim 47, wherein the series of connections is generated progressively, wherein generation of said series of connections comprises determining a connection between a current waypoint and an interaction area of a next target, wherein the next area is determined based on at least one of:
(i) a distance between the current waypoint and the interaction area of the next target; and
(ii) a level of priority of the next target indicative of a priority to perform an interaction between the payload and the next target.

63. The system of claim 47, wherein (i) or (ii) is met:
(i) the system is configured to, for a given period of time T1:
determine a given moving target among the plurality of targets for which a distance between a position of the aerial vehicle at time T1 and a position of the given moving target at time T1 or an interaction area of the given moving target at time T1 meets a criterion,
estimate a time ΔTtarget for the aerial vehicle to reach the given moving target or the interaction area of the given moving target,
predict position of moving targets of the plurality of targets at time T1+ΔTtarget,
generate a connection between the position of the aerial vehicle at time T1 and an interaction area of a given target of the plurality of targets, wherein the interaction area is estimated for a position of the given target at time T1+ΔTtarget;
(ii) the system is configured to, for a given period of time T1:
determine a given moving target among the plurality of targets for which a distance between a position of the aerial vehicle at time T1 and a position of the given moving target at time T1 or an interaction area of the given moving target at time T1 meets a criterion,
estimate a time ΔTtarget for the aerial vehicle to reach the given moving target or the interaction area of the given moving target,
predict position of moving targets of the plurality of targets at time T1+ΔTtarget,
generate a connection between the position of the aerial vehicle at time T1 and an interaction area of a given target of the plurality of targets, wherein the interaction area is estimated for a position of the given target at time T1+ΔTtarget,
wherein a distance between a position of the aerial vehicle at time T1 and a position of the given target at time T1+ΔTtarget or an interaction area of the given target at time T1+ΔTtarget meets the criterion.

64. The system of claim 47, configured to:
for the given period of time T1:
(10) determine a given moving target among the plurality of targets for which a distance between a starting waypoint Wi and a position of the given moving target at time Ti or an interaction area of the given moving target at time Ti meets a criterion, wherein, at a first iteration of (10), Ti is equal to T1 and Wi corresponds to a position of the aerial vehicle at time T1,
(11) estimating a future time Ti+1 at which the aerial vehicle, starting from Wi, will reach the given moving target or the interaction area of the given moving target,
(12) predicting position of one or more moving targets of the plurality of targets at time Ti,
(13) generating a connection between Wi and an interaction area of a given target of the plurality of targets, wherein the interaction area is estimated for a position of the given target at time Ti+1, wherein a distance between Wi and a position of the given target at time Ti+1 or an interaction area of the given target at time Ti+1 meets the criterion,
(14) repeating (10) to (13) at least once, wherein for said repeating Wi is set equal to an extremity of the connection determined at (13) and Ti is set equal to Ti+1.

65. An aerial vehicle comprising:
a payload operative to perform an interaction with a target,
one or more processing circuitries configured to:
for each target of a plurality of targets, determine an interaction area based on a position of the target,
wherein, for each position of the aerial vehicle located in the interaction area of the target, the interaction between the payload and the target is enabled according to an operability criterion,
divide the plurality of targets into a plurality of clusters, wherein at least one cluster comprises at least two targets of the plurality of targets, wherein said dividing is based on a distribution of distance between the targets,
determine an order between the plurality of clusters,
generate a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections, and
obtain a flight path for the aerial vehicle using the series of connections, wherein said flight path follows said order between the plurality of clusters.

66. A non-transitory storage device readable by one or more processing circuitries, tangibly embodying a program of instructions executable by the one or more processing circuitries to perform, for an aerial vehicle comprising a payload operative to perform an interaction with a target:
for each target of a plurality of targets, determining an interaction area based on a position of the target,
wherein, for each position of the aerial vehicle located in the interaction area of the target, the interaction between the payload and the target is enabled according to an operability criterion,
dividing the plurality of targets into a plurality of clusters, wherein at least one cluster comprises at least two targets of the plurality of targets, wherein said dividing is based on a distribution of distance between the targets,
determining an order between the plurality of clusters,
wherein at least one target of the plurality of targets is a moving target, generating a series of connections, wherein each connection comprises at least one waypoint located in an interaction area of a target of the plurality of targets and at least one waypoint located in an interaction area of another different target of the plurality of targets, wherein each interaction area comprises a waypoint of at least one connection of the series of connections, and
obtaining a flight path for the aerial vehicle using the series of connections, wherein said flight path follows said order between the plurality of clusters.
